(19) United States
(12) Patent Application Publication
(10) Pub. No.: US 2002/0141682 A1
(43) Pub. Date: Oct. 3, 2002

(54) Spot-size converter integratrd laser diode and method for fabricating the same

(76) Inventors: Sang-Wan Ryu, Taejon (KR); Je Ha Kim, Taejon (KR)

Correspondence Address: JACOBSON HOLMAN, PLLC, PROFESSIONAL LIMITED LIABILITY COMPANY, 400 Seventh Street, N.W., Washington, DC, 20004, US

(21) Appl. No.: 09/995,705

(22) Filed: Nov. 29, 2001

(30) Foreign Application Priority Data
Apr. 2, 2001 (KR) 2001-17315

(51) Int. Cl. G02B 6/12; G02B 6/26

(52) U.S. Cl. 385/14; 385/50; 385/43

(57) ABSTRACT

A spot-size converter integrated optical device and method for manufacturing the same readily fabricates and optimizes a laser and a spot-size converter region. The optical device includes: a first waveguide; and a second waveguide basically having a planar buried-heterostructure active layer and a spot-size converter region of ridge form where optical mode expands for better power coupling to an optical fiber, wherein the spot-size converter region is formed by tapering the width of the active layer.

### FIELD OF THE INVENTION

The present invention relates to optical devices; and, more particularly, to a spot-size converter integrated laser diode and method for fabricating the same.

### PRIOR ART OF THE INVENTION

In general, optical coupling between a laser and an optical fiber should be easily and economically accomplished without using complicated optic components such as lenses in order to manufacture a low-cost light source module for use in an optical subscriber line. However, general semiconductor lasers have high-coupling loss when coupling an output light into a single-mode optical fiber, which is due to significant discrepancy between the mode size of a laser and that of a single-mode optical fiber.

Usually, a mode size of the semiconductor laser is around 1 μm and the mode has an elliptical shape whose vertical size is different from its horizontal size. On the other hand, a mode size of the single-mode optical fiber is around 10 μm and the mode has a circular shape.

In order to solve the above discrepancy problem, various researches have been actively carried out for a spot-size converter (SSC) structure which expands a mode size of the output light from a laser region and facilitates the coupling into the single-mode optical fiber by converting its mode size and shape. By using the SSC, it is possible to accomplish direct optical coupling without using a lens located between the laser and the optical fiber and obtain low-coupling loss and large positional alignment tolerances.

Hereinafter, there are shown some points that should be considered in designing the SSC integrated laser structure. First of all, in order to realize a high performance operation of the laser, in the laser region, a spot should be well confined in a laser active layer. This increases an optical confinement factor and, thus, plays a role in lowering an operation current of the laser.

However, in the SSC region, the spot confined in the laser active layer are gradually emitted to thereby sufficiently expand a spot size at an output interface and the SSC region should play a role in converting the spot size without radiation loss of the light.

Recently, there have been introduced various SSC structures. Among the SSC structures, representative several structures will be shown hereinbelow.

One of them is a structure of converting a waveguide thickness by using a selective area growth method and illustrated in FIG. 1.

FIG. 1 shows a schematic view of a first example of the conventional spot-size converter integrated laser structures. The SSC region is connected to a laser waveguide by using a butt-joint coupling scheme. Herein, although the waveguide thickness near the butt-joint is large, the thickness gradually decreases as going to an end of the SSC region and, finally, the thickness should be smaller than 0.2 μm at the end. The selective area growth method is used to make the structure whose waveguide thickness becomes smaller along the SSC region.

In FIG. 1, there are shown an n-type electrode 11, an n-type InP cladding layer 12, p-type and n-type InP current blocking layers 13 and 14, respectively, a p-InP cladding layer 15, a p-type electrode 16, a passive waveguide 17, a laser active layer 18 and a butt-joint interface.

However, the above first example has some problems. First, since the material composition changes by the selective area growth, a growing layer introduces stress and, thus, a crystal quality is deteriorated by severe stress provided to the growing layer. Second, since a crystal growing condition should be strictly maintained so as to carry out the selective area growth, tolerances in the crystal growing process become smaller.

In order to solve the above problems, there has been introduced a method for gradually decreasing a waveguide width to thereby expand the mode size without converting the waveguide thickness. This method has an advantage of not using the selective area growth while it has a difficulty of precisely adjusting the waveguide width up to 0.2˜0.3 μm. This precision can be accomplished by using, e.g., E-beam lithography, not photolithography. However, the E-beam lithography is not appropriate for mass production.

In the above two methods, since the mode shape of the output light is determined by the waveguide structure at the end of the SSC region, the properties of the SSC become substantially different according to the waveguide shape at the end. However, it is not easy to precisely control the waveguide shape at the end as optimizing the other properties of the SSC, e.g., the radiation loss, the length of SSC region, etc.

As a solution of the above problems, there has been introduced a SSC with a double waveguide core structure. According to this method, two waveguides A and B are formed in the SSC region: one waveguide A is optically coupled with a laser region and emits light by gradually decreasing its size and then, the other waveguide B, which is previously formed with a large mode size for the optical coupling with optical fiber, confines the light emitted from the waveguide A.

Herein, the SSC region plays a role in decreasing the thickness and width of the waveguide A and coupling the light of the waveguide A to the waveguide B. As a result, this method can obtain a stabilized property in converting the mode size regardless of processing factors since the mode shape at the end of the SSC region is determined by the shape of the waveguide B not that of the waveguide A.

There will be provided applications of this method.

Referring to FIG. 2, there is illustrated a schematic view of a second example of conventional spot-size converter integrated laser structures. This example shows that the width of a laser active layer decreases gradually in the SSC region so as to couple the laser active layer to a thin waveguide that is formed down of the structure. Through the double etching processes, there are formed a upper waveguide used as a laser active layer 22 and a lower waveguide used as a spot size converting layer 21. Then, a p-type InP cladding layer 23 is grown as a whole on the upper and lower waveguide to thereby protect the laser active layer 22. An unnecessary p-n junction formed near the laser active layer 22 is removed by implanting proton and, then, a p-type electrode 25 is formed thereon.

Although the manufacturing process of the second example is simple, it has a disadvantage of introducing leakage current since the unnecessary p-n junction exists around the waveguide used as the spot-size converting layer 21 as well as near the laser active layer 22. In the meantime, although it is possible to partially remove the unnecessary p-n junction by using the proton implantation, the second example cannot completely remove the p-n junction and is not possible to achieve the laser properties as good as those of the general planar buried-heterostructure (PBH) lasers.

Referring to FIG. 3, there is provided a cross-sectional view of a third example of the conventional spot-size converter integrated laser structures.

As described in FIG. 3, a part of a laser active layer 33 including the quantum well layer is removed and a waveguide for a taper is regrown. Then, a taper layer 32 is formed by gradually decreasing a width of the waveguide and optical power is coupled to a thin waveguide 31 formed down of the taper layer 32.

Sequentially, an InP layer 34 is re-grown on an entire SSC region to protect the waveguide and a mesa is formed in the laser region. A planar buried-heterostructure laser structure is completed by two times of re-growth. Finally, a ridge waveguide is formed in the SSC region.

The above third example has an advantage of independently optimizing a design for each region by constructing the flat-buried laser structure in the laser region and the double waveguide core structure in the SSC region while its manufacturing process becomes severely complicated since a tolerance of each process is very small.

According to researches released by now, in order to obtain the best performances, the laser should have the planar buried-heterostructure and the SSC must have the double waveguide core structure.

However, in accordance with the conventional method described above, a structure capable of simplifying the SSC manufacturing deteriorates the laser properties a whole and, on the other hand, a structure enhancing the laser properties makes the SSC properties worse. Meanwhile, a structure optimizing the laser region together with the SSC region requires a significantly complicated process, resulting in increasing its manufacturing cost and deteriorating its product yield.

Therefore, it is desired to introduce a structure and manufacturing method capable of optimizing the laser region and the SSC region at the same time without using the complicated structure so as to overcome the problems of the conventional structures and to manufacture a SSC integrated laser of high performance economically.

### SUMMARY OF THE INVENTION

It is, therefore, a primary object of the present invention to provide a spot-size converter integrated laser and method for manufacturing the same that can be easily fabricated and optimizes a laser and spot-size converter regions together.

In accordance with one aspect of the present invention, there is provided a spot-size converter integrated optical device including: a first waveguide; and a second waveguide basically consisting of a planar buried-heterostructure and a spot-size converter region of ridge form in which a spot is coupled to the first waveguide, wherein the spot-size converter region is formed to have a taper, which a width of the active layer decreases.

In accordance with another aspect of the present invention, there is provided a method for manufacturing a spot-size converter integrated optical device, comprising the steps of: sequentially forming a first waveguide, a separating layer and a second waveguide; constructing a dielectric layer pattern on the second waveguide; etching the second waveguide through the use of a mask of the dielectric layer pattern and making a laser active layer and a spot-size converter region at the same time; forming a current blocking layer on a side of the second waveguide; making a cladding layer on a whole surface including the current blocking layer; constructing a ridge pattern by selectively etching the cladding layer, the current blocking layer up to the first waveguide; and forming a polyimide layer on both sides of the ridge pattern.

Preferably, in the step of etching the second waveguide, the spot-size converter region is formed to have double slopes having first part of a large slope and a second part of a small slope.

### BRIEF DESCRIPTION OF THE DRAWINGS

The above and other objects and features of the present invention will become apparent from the following description of preferred embodiments given in conjunction with the accompanying drawings, in which:

FIG. 1 shows a schematic view of a first example of conventional spot-size converter integrated laser structures;

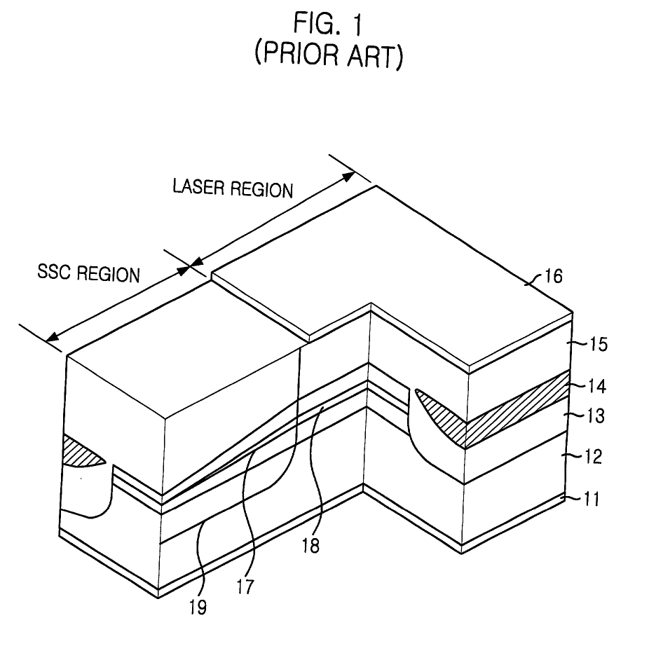

FIG. 2 illustrates a schematic view of a second example of conventional spot-size converter integrated laser structures;

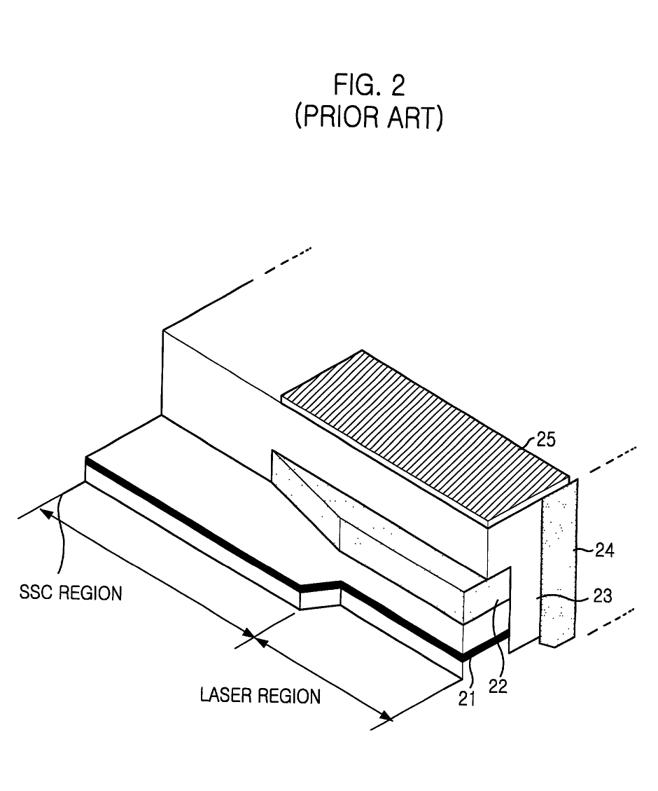

FIG. 3 is a schematic view of a third example of conventional spot-size converter integrated laser structures;

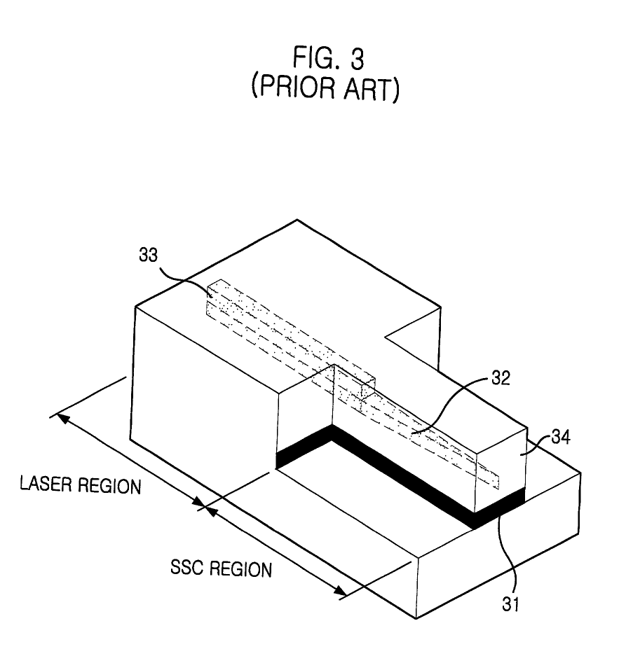

FIG. 4 provides a conceptional view of a spot-size converter integrated laser structure in accordance with an embodiment of the present invention;

FIG. 5A represents a cross-sectional view of a waveguide region cut by a line A-A′ shown in FIG. 4;

FIG. 5B depicts a graph of showing a refractive index of each layer constructing the waveguide region in FIG. 4;

FIG. 6A shows a cross-sectional view of the laser structure cut by a line B-B′ described in FIG. 4;

FIG. 6B provides a cross-sectional view of the laser structure cut by a line C-C′ illustrated in FIG. 4;

FIGS. 7A to 7F illustrate cross-sectional views of showing a manufacturing process of a spot-size converter integrated PBH laser in accordance with an embodiment of the present invention; and

FIG. 8 presents a conceptional view of a silicon nitride film pattern formed for performing the etching process shown in FIG. 7B and a waveguide pattern formed by using the silicon nitride film pattern.

### DETAILED DESCRIPTION OF THE PREFERRED EMBODIMENTS

Hereinafter, with reference to the drawings, a preferred embodiment of the present invention will be explained in detail.

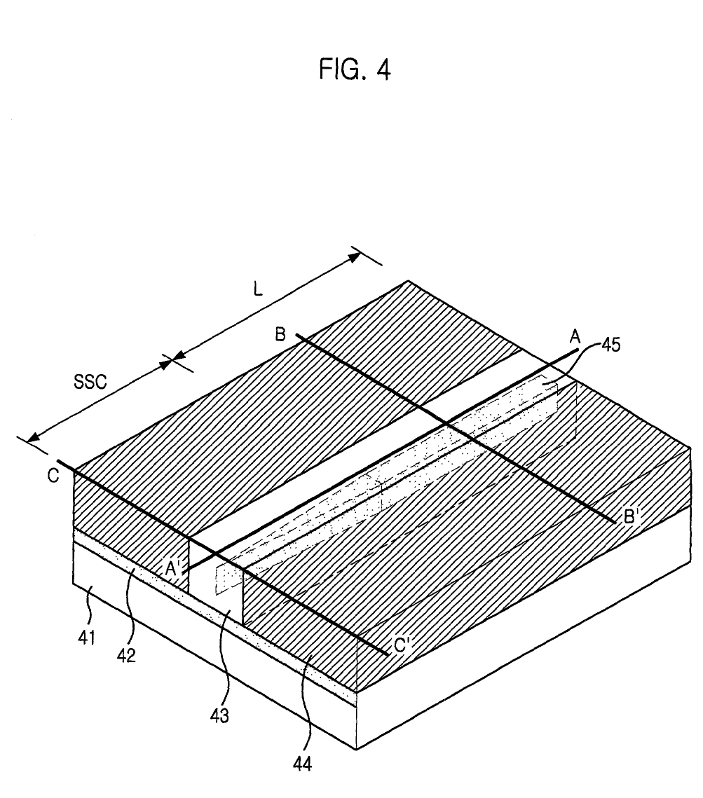

Referring to FIG. 4, there is provided a conceptional view of a spot-size converter integrated laser in accordance with an embodiment of the present invention, wherein a ridge is formed for lateral confinement of a lower waveguide.

A ridge core layer 42 and a laser active layer 45 are formed as a first waveguide and a second waveguide, respectively. Then, a laser region L is constructed by vertically etching the laser active layer 45. At this time, in order to make a spot-size converter region SSC, the etching process is performed in a slope of decreasing a width of the laser active layer 45 of the second waveguide.

Herein, the ridge core layer 42 is thin for optical mode expansion and the laser active layer 45 is thicker than the ridge core layer 42. The width of the laser active layer 45 gets smaller as going to an end of the spot-size converter region SSC.

This manufacturing process is explained in detail with reference to FIG. 4.

An n-InP cladding layer 41 and the ridge core layer 42 are sequentially formed on a substrate (not shown). Then, the laser active layer 45 buried in an InP layer 43 is made on the ridge core layer 42. Further, a polyimide layer 44 is formed on the ridge core layer 42 to thereby protect the laser region L and the spot-size converter region SSC.

As described above, the laser in accordance with the embodiment of the present invention basically consists of a double waveguide core, e.g., the ridge core layer 42 and the laser active layer 45. Although the width of the laser active layer 45 is generally maintained about 1˜2 μm same as that in a PBH laser manufacturing process, the width gradually decreases in the spot-size converter region SSC and completely disappears at the end of the spot-size converter region SSC.

Through the above manufacturing method, the laser region L can have a high optical confinement factor to thereby guarantee a high-performance laser operation and, in the spot-size converter region SSC, the spot confined in the laser active layer 45 is gradually transferred to the ridge core layer 42 to thereby increase the spot size and, finally, accomplish effective coupling with optical fiber by reducing a radiation angle.

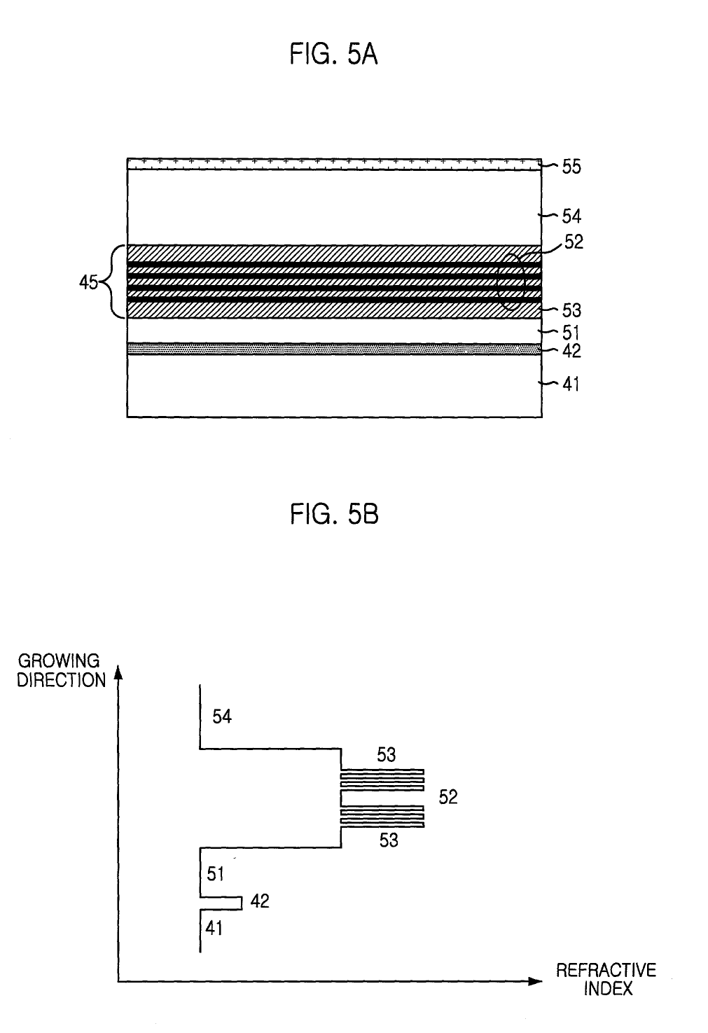

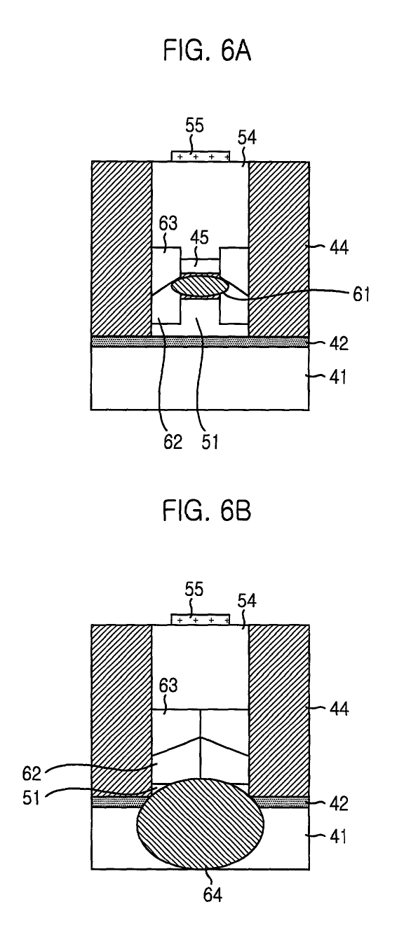

FIG. 5A represents a cross-sectional view of a waveguide region cut by a line A-A′ shown in FIG. 4 and FIG. 5B depicts a graph of showing a refractive index of each layer constructing the waveguide region in a growing direction.

As illustrated in FIG. 5A, the ridge core layer 42 of the first waveguide is made of InGaAsP (Eg=1.13 eV) of 50 nm and the second waveguide is formed by the laser active layer 45 consisting of InGaAsP (Eg=1.0 eV) used as the optical confining layer 53 and multiple quantum wells 52. In order to separate two waveguides, the n-InP separating layer 51 is inserted between two waveguides. Then, an entire waveguide structure is constructed by growing the p-InP cladding layer 54 and a p⁺-InGaAs layer 55 on the above processing structure.

Referring to FIG. 5B, the ridge core layer 42 of the first waveguide has a smaller refractive index difference with the InP cladding and the thickness is small enough that optical mode size is large, while the optical mode of active waveguide is small due to tight mode confinement of the waveguide.

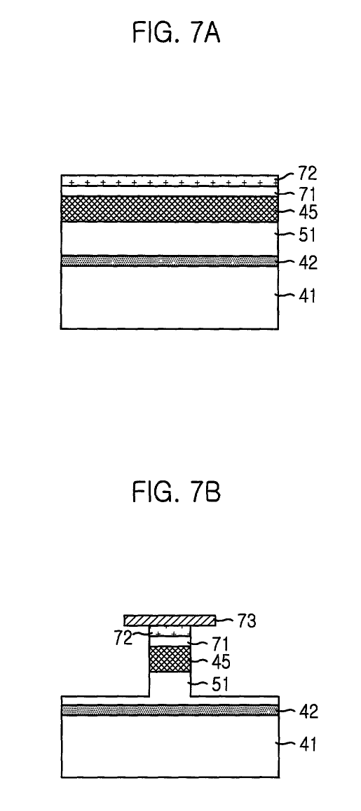

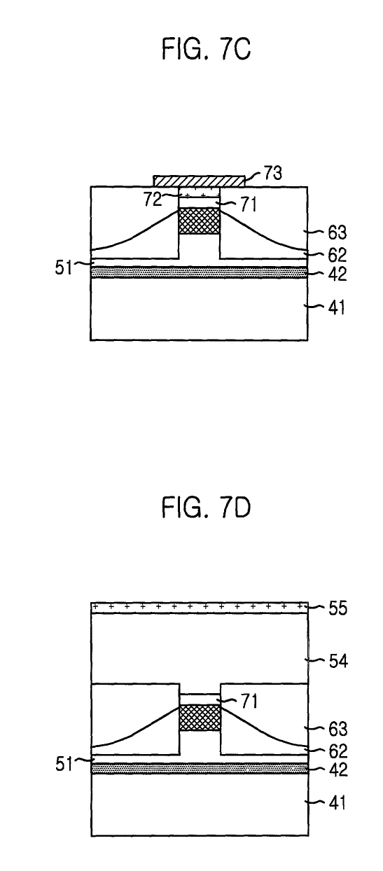

Referring to FIG. 6A, there is depicted a cross-sectional view of the laser structure cut by a line B-B′ described in FIG. 4, which shows only the laser region L.

As illustrated in FIG. 6A, there are in the laser region L two waveguides, i.e., the ridge core layer 42 and the laser active layer 45. At this time, a spot distribution part 61 is determined by the laser active layer 45, which is relatively thick and has a larger refractive index difference. As a result, it is possible to obtain optical mode well confined in the laser active layer. This is identical with the case of a general laser structure.

Referring to FIG. 6B, there is provided a cross-sectional view of the laser structure cut by a line C-C′ illustrated in FIG. 4, which shows the end of the spot-size converter region SSC.

As described in FIG. 6B, the laser active layer 45 at the end of the spot-size converter region SSC is totally etched out or, if exists, width of the laser active layer 45 is small enough. Therefore, the laser active layer 45 does not influence to the spot distribution and the ridge core layer 42 of the first waveguide determines a mode property of the output light. Since the ridge core layer 42 has a small refractive index difference and a thin thickness and, thus, its ability of optical confinement is not good, a large spot distribution part 64 is constructed. As a result, it is possible to design the spot-size converter region SSC according to the structure of the ridge core layer 42.

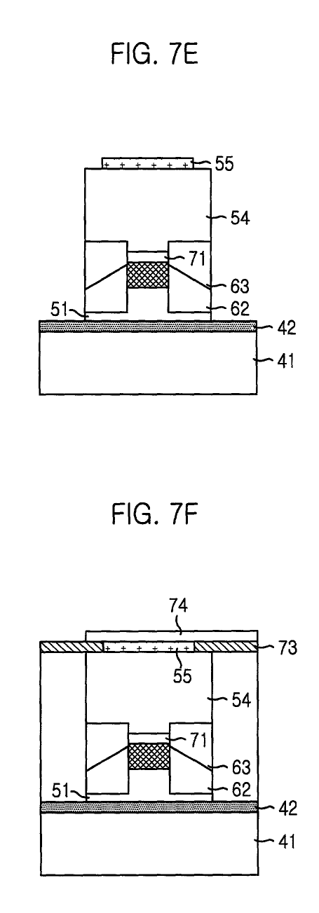

Referring to FIGS. 7A to 7F, there are illustrated cross-sectional views of showing a manufacturing process of a spot-size converter integrated PBH laser in accordance with an embodiment of the present invention.

In FIG. 7A, the n-InP cladding layer 41, the ridge core layer 42, the n-InP separating layer 51 and the laser active layer 45 are sequentially formed on an InP substrate (not shown). After then, a p-InP layer 71 and an InGaAs layer 72 are grown on the surface of the laser active layer 45. Herein, the InGaAs layer 72 is used to adjust an etching shape in a following etching process.

As shown in FIG. 7B, after depositing a silicon nitride film 73 on the InGaAs layer 72 and forming a pattern of the silicon nitride film 73 for constructing a waveguide, the second waveguide is defined by etching the InGaAs layer 7, the p-InP layer 71, the laser active layer 45 and the n-InP separating layer 51 by using the pattern of the silicon nitride film 73.

At this time, wet etching is performed so as to make an undercut beneath the pattern of the silicon nitride film 73 and the width of the second waveguide is narrower than the pattern of the silicon nitride film 73.

In other words, the waveguide pattern requiring a precise adjustment less than about 1 μm can be readily formed by using the silicon nitride film pattern whose width is about 2˜3 μm and the undercut. The pattern having the width of about 2˜3 μm can be made by photolithography, resulting in simplifying the manufacturing process.

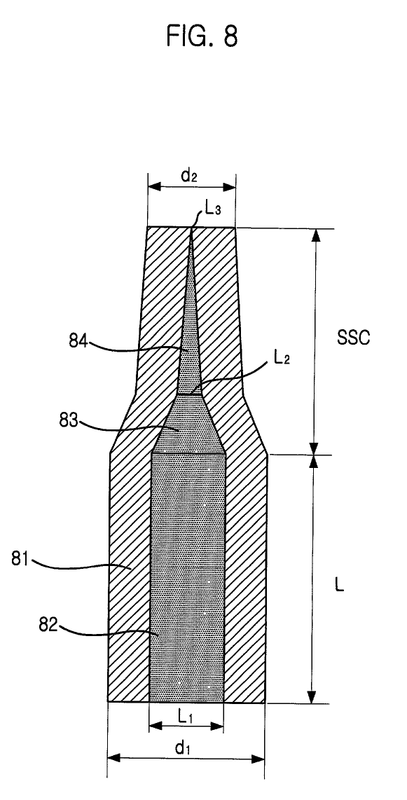

Referring to FIG. 8, there is presented a conceptional view of a silicon nitride film pattern 81 and a waveguide pattern 82.

If the undercut used in etching is 1 μm, a width of a generally used laser active layer waveguide is 1.5 μm and, thus, the silicon nitride film pattern 81 has a width of 3.5 μm.

The width of the waveguide gradually decreases and finally becomes 0 in the spot-size converter region SSC and this pattern gradually decreases the width (d₁=3.5 μm, d₂=2 μm) of the pattern formed in the silicon nitride film 81 until the width becomes 2 μm. This process is readily implemented by using the undercut etching.

Meanwhile the spot-size converter region SSC includes two regions 83 and 84 where the pattern width decreases with slopes different from each other.

That is to say, since the region where the waveguide width is converted from 1.5 μm (L₁) to 0.5 μm (L₂) is not related to the optical loss, the length of the spot-size converter region SSC is reduced by about less than 50 μm by increasing the slope. At this time, there may occur the optical loss if the slope becomes large in the region 84 whose waveguide width is equal to or less than 0.5 μm, it is required to slowly move the spot by decreasing the slope.

As a result, length of the device including the spot-size converter region SSC is effectively controlled and, thereafter, the operational efficiency of the laser can be maintained.

As depicted in FIG. 7C, to form the PBH structure by using the pattern of the silicon nitride film 73, p-n-p current blocking layers 62 and 63 are re-grown.

In FIG. 7D, after removing the pattern of the silicon nitride film 73 and the InGaAs layer 72, the p-InP cladding layer 54 and the p⁺-InGaAs layer 55 for reducing a contact resistance are formed on the above processing structure.

In FIG. 7E, after constructing a p⁺-InGaAs pattern 55a to suppress current spreading, a ridge structure is formed by selectively etching the p-InP cladding layer 54, the p-n-p current blocking layers 62 and 63 and the n-InP separating layer 51 beneath the p⁺-InGaAs pattern 55a. At this time, in order to precisely adjust the width and length of the ridge structure, both of reactive ion etching (RIE) and selective wet etching are used.

As descried in FIG. 7F, after the ridge structure is formed, the polyimide 44 is filled so as to smooth the surface of the ridge structure; a protecting film is made on the polyimide 44 and the p⁺-InGaAs pattern 55a by using the silicon nitride film 73; and a p-type metal electrode 74 is deposited, wherein this electrode 74 is connected to the p⁺-InGaAs pattern 55.

As shown above, the spot-size converter integrated PBH laser, wherein the spot-size converter is of the ridge structure, is fabricated with only one etching process and the polyimide process added to the conventional PBH laser. Since the entire process of the conventional PBH laser is already well known and the added etching and polyimide process has good processing compatibility, it is possible to accomplish economical mass production of the spot-size converter integrated laser structure without additional difficulties in the manufacturing process by using the above inventive method. Moreover, the laser manufactured through the above process is optimized to the PBH structure and the SSC region is made of the double waveguide core structure by using the ridge formation, which means that two regions are optimized.

Meanwhile, another embodiment of the present invention uses a structure of changing a band gap of the laser active layer in the SSC region by using the selective area growth method during the fist epi-growth in the first embodiment of the present invention. In this structure, since there does not occur absorbing in the SSC region and thus there is no need of current injection, there is an effect to reduce the operation current of the laser.

In accordance with still another embodiment of the present invention, the spot-size converter having the ridge form introduced by the first embodiment is combined with a PBH waveguide structure. The PBH structure is used in a semiconductor optical amplifier, an optical modulator, a multimode interferometer, etc., in addition to the laser.

Through the use of the embodiments of the present invention, the SSC region of the double waveguide core structure and the PBH laser region can be optimized at the same time and the manufacturing process is also simplified.

Furthermore, it is easy to couple the laser output light with the optical fiber, so that the cost for the optical alignment is reduced and the optical coupling efficiency is substantially enhanced.

While the present invention has been described with respect to the particular embodiments, it will be apparent to those skilled in the art that various changes and modifications may be made without departing from the spirit and scope of the invention as defined in the following claims.

What is claimed is:

1. A spot-size converter integrated optical device, comprising:
a first waveguide; and
a second waveguide basically including a planar buried-heterostructure active layer and a spot-size converter region of ridge form in which a spot is coupled to the first waveguide,
wherein the spot-size converter region is formed by tapering a width of the active layer.

2. The spot-size converter integrated optical device as recited in claim 1, wherein the first waveguide includes layers whose refractive indices are smaller than that of the second waveguide and the first waveguide is thinner than the second waveguide.

3. The spot-size converter integrated optical device as recited in claim 1, wherein the second waveguide is undercut-etched.

4. The spot-size converter integrated optical device as recited in claim 1, wherein the spot-size converter region includes two parts in which in a first part, a width of the planar buried-heterostructure active layer decreases with relatively large slope, while in a second part, the width of the planar buried-heterostructure active layer decreases with small slope.

5. The spot-size converter integrated optical device as recited in claim 4, wherein the first part has a width of about 0.5˜1.5 μm and the second part has a width of about 0˜0.5 μm.

6. The spot-size converter integrated optical device as recited in claim 1, wherein the second waveguide is formed by a selective area growth method.

7. The spot-size converter integrated optical device as recited in claim 1, wherein a separating layer is inserted between the first waveguide and the second waveguide.

8. The spot-size converter integrated optical device as recited in claim 1, wherein the planar buried-heterostructure active layer any one active layer of a semiconductor optical amplifier, an optical modulator and a multimode interferometer.

9. A method for manufacturing a spot-size converter integrated optical device, comprising the steps of:
sequentially forming a first waveguide, a separating layer and a second waveguide;
constructing a dielectric layer pattern on the second waveguide;
etching the second waveguide through the use of a mask of the dielectric layer pattern and making a laser active layer and a spot-size converter region at the same time;
forming a current blocking layer on a side of the second waveguide;
making a cladding layer on a whole surface including the current blocking layer;
constructing a ridge pattern by selectively etching the cladding layer, the current blocking layer and the second waveguide; and
forming a polyimide layer on both sides of the ridge pattern.

10. The method as recited in claim 9, wherein, in the step of constructing the dielectric layer pattern, the dielectric layer pattern contains a silicon nitride film and has a width of about 2˜3 μm.

11. The method as recited in claim 9, wherein the step of etching the second waveguide is performed by wet etching.

12. The method as recited in claim 9, wherein, in the step of etching the second waveguide, the spot-size converter region is formed to have a slope of decreasing a width of the laser active layer and includes a first part of a large slope and a second part of a small slope.

13. The method as recited in claim 9, wherein the step of constructing the ridge pattern employs reactive ion etching and selective wet etching.
